(19) United States
(12) Patent Application Publication
(10) Pub. No.: US 2025/0251162 A1
(43) Pub. Date: Aug. 7, 2025

(54) METHOD FOR CONTROLLING AIR CONDITIONER AND AIR CONDITIONER

(71) Applicant: GREE GREEN REFRIGERATION TECHNOLOGY CENTER CO., LTD. OF ZHUHAI, Zhuhai, Guangdong (CN)

(72) Inventors: Yasong TIAN, Zhuhai, Guangdong (CN); Bo LIANG, Zhuhai, Guangdong (CN); Zhiwei CHEN, Zhuhai, Guangdong (CN); Min LIAO, Zhuhai, Guangdong (CN)

(21) Appl. No.: 18/854,348

(22) PCT Filed: Dec. 21, 2022
(86) PCT No.: PCT/CN2022/140818

§ 371 Date: Oct. 4, 2024

(30) Foreign Application Priority Data
Jun. 21, 2022 (CN) 202210707300.8

(51) Int. Cl. F24F 11/42; F24F 11/61; F24F 11/64; F24F 11/84; F24F 11/86; F24F 110/10; F24F 140/20

(52) U.S. Cl. CPC F24F 11/42; F24F 11/61; F24F 11/64; F24F 11/84; F24F 11/86; F24F 2110/10; F24F 2140/20

(57) ABSTRACT

Some embodiments of the disclosure provide a method for controlling an air conditioner, and an air conditioner. The method for controlling an air conditioner includes: controlling the air conditioner to enter a defrosting mode; acquiring a current frequency F_{actual} of a compressor of the air conditioner and a current opening P of an electronic expansion valve of the air conditioner in the defrosting mode; controlling the air conditioner to enter a first defrosting stage and operate in the first defrosting stage for first preset duration; and controlling the compressor to operate at a first frequency F₁ and the electronic expansion valve to operate at a first opening P₁ when the air conditioner is in the first defrosting stage.

### CROSS-REFERENCE TO RELATED APPLICATION

The disclosure is a national stage application of International Patent Application No. PCT/CN2022/140818, which is filed on Dec. 21, 2022, and claims the priority of patent application No. 202210707300.8, filed with the China National Intellectual Property Administration on Jun. 21, 2022 and entitled “Method for controlling air conditioner, and air conditioner”.

### TECHNICAL FIELD

The disclosure relates to the technical field of household appliances, and in particular to a method for controlling an air conditioner, and an air conditioner.

### BACKGROUND

Existing air conditioners are all heat pump type air conditioners, which offer home heating during the cold season. When the air conditioner operates for a period of time, since an outdoor heat exchanger absorbs heat from outdoor air, a temperature around the outdoor heat exchanger is low, and water vapor in the air condenses into frost and adheres to a surface of the outdoor heat exchanger. In consequence, a heat exchange capacity of the outdoor heat exchanger is affected, a heat exchange efficiency of the air conditioner is also affected, and an air outlet temperature of an indoor unit and a degree of user comfort are affected accordingly. In bad weather, a thick frost layer may even cover an outdoor unit, which seriously affects the degree of user comfort when the air conditioner is in use. To solve the problem, it is common practice to defrost the air conditioner.

According to an existing defrosting method, after determining that a thick frost layer is formed on the outdoor unit and seriously affects an indoor heating capacity, the air conditioner is switched from a heating mode to a cooling mode. Therefore, high-temperature and high-pressure gas from a compressor directly enters a heat exchanger of the outdoor unit, so as to melt the frost layer on the heat exchanger. However, in this way, no heat will be conveyed to the room for a period of time after defrosting begins, and moreover, heat in the room will be absorbed, causing an indoor temperature to decrease. The longer the defrosting time is, the more obvious the indoor temperature decrease is, and the lower the degree of user comfort is.

In addition, according to another defrosting method, an electrical auxiliary heating device is additionally arranged on the heat exchanger of the outdoor unit, and alternatively, a pipeline bypassing the outdoor unit or heat exchangers arranged side by side are additionally provided, so as to improve indoor comfort during defrosting. However, these methods are costly.

### SUMMARY

A primary objective of the disclosure is to provide a method for controlling an air conditioner, and an air conditioner. Therefore, the problem that a degree of user comfort is affected since an indoor ambient temperature is decreased obviously when an air conditioner is in a defrosting mode is solved.

In order to realize the above objective, in an aspect, the disclosure provides a method for controlling an air conditioner. The method includes: controlling the air conditioner to enter a defrosting mode; acquiring a current frequency F_{actual} of a compressor of the air conditioner and a current opening P of an electronic expansion valve of the air conditioner in the defrosting mode; controlling the air conditioner to enter a first defrosting stage and operate in the first defrosting stage for first preset duration; and controlling the compressor to operate at a first frequency F₁ and the electronic expansion valve to operate at a first opening P₁ when the air conditioner is in the first defrosting stage; where a method for determining the first frequency F₁ includes: F₁=kF_{actual}, where k is a frequency decrease adjustment coefficient, the frequency decrease adjustment coefficient k is determined according to an indoor ambient temperature T, the higher the indoor ambient temperature T is, the smaller the frequency decrease adjustment coefficient k is, and 0<k<1; and a method for determining the first opening P₁ includes: comparing the first frequency F₁ with a preset frequency Fₚᵣₑₛₑₜ, where P₁=Pₘₐₓ when F₁≥Fₚᵣₑₛₑₜ; and P₁=Pₘₐₓ*F₁/Fₚᵣₑₛₑₜ WHEN F₁<Fₚᵣₑₛₑₜ.

In some embodiments, a method for determining the frequency decrease adjustment coefficient k according to the indoor ambient temperature T includes: k=k₁ when T<15° C.; k=k₂ when 15° C.≤T<20° C.; k=k₃ when 20° C.≤T≤25° C.; and k=k₄ when T>25° C.; where 0.4≤k₁≤0.6; 0.4≤k₂≤0.6; 0.4≤k₃≤0.6; 0.4≤k₄≤0.6; and k₁≥k₂≥k₃≥k₄.

In some embodiments, the preset frequency Fₚᵣₑₛₑₜ is 50 Hz.

In some embodiments, the first preset duration is greater than or equal to 30 s and less than or equal to 90 s.

In some embodiments, after the first defrosting stage ends, the method for controlling an air conditioner further includes: controlling the air conditioner to enter a second defrosting stage and operate in the second defrosting stage for third preset duration; where the compressor operates at a third frequency F₃, and the electronic expansion valve operates at a third opening P₃ when the air conditioner is in the second defrosting stage, the third frequency F₃ is greater than the first frequency F₁, and the third opening P₃ is less than the first opening P₁; and controlling a frequency of the compressor to increase from the third frequency F₃ to the current frequency F_{actual}, and controlling an opening of the electronic expansion valve to decrease from the third opening P₃ to the current opening P after the second defrosting stage ends, so that the air conditioner exits the defrosting mode.

In some embodiments, after the first defrosting stage and before the second defrosting stage, the method for controlling an air conditioner further includes: controlling the air conditioner to enter a transitional defrosting stage and operate in the transitional defrosting stage for second preset duration; where the compressor operates at a second frequency F₂, and the electronic expansion valve operates at a second opening P₂ when the air conditioner is in the transitional defrosting stage, the second frequency F₂ is greater than the first frequency F₁ and less than the third frequency F₃, and the second opening P₂ is less than the first opening P₁ and greater than the third opening P₃.

In some embodiments, after the second defrosting stage ends, and before the opening of the electronic expansion valve is decreased from the third opening P₃ to the current opening P, the method for controlling an air conditioner further includes: maintaining the opening of the electronic expansion valve at the third opening P₃ for fourth preset duration.

In some embodiments, a method for determining the second frequency F₂ includes: F₂=F₁+ΔF₁, where 0 Hz≤ΔF₁≤5 Hz.

In some embodiments, the method for determining the second frequency F₂ includes: comparing the first frequency F₁ with the preset frequency Fₚᵣₑₛₑₜ, where ΔF₁=1 Hz when F₁≥Fₚᵣₑₛₑₜ, and ΔF₁=2 Hz when F₁<Fₚᵣₑₛₑₜ.

In some embodiments, a method for determining the second opening P₂ includes: P₂=4/5*P₁*F₂/Fₚᵣₑₛₑₜ, where an upper limit of the second opening P₂ is 450 steps.

In some embodiments, the second preset duration is greater than or equal to 30 s and less than or equal to 90 s.

In some embodiments, a method for determining the third frequency F₃ includes: F₃=F₂+ΔF₂, where 0 Hz≤ΔF₂≤5 Hz.

In some embodiments, the method for determining the third frequency F₃ includes: comparing the second frequency F₂ with the preset frequency Fₚᵣₑₛₑₜ, where ΔF₂=1 Hz when F₂≥Fₚᵣₑₛₑₜ, and ΔF₂=2 Hz when F₂<Fₚᵣₑₛₑₜ.

In some embodiments, a method for determining the third opening P₃ includes: P₃=3/5*P₂*F₃/Fₚᵣₑₛₑₜ, where an upper limit of the third opening P₃ is 350 steps.

In some embodiments, T_{outer pipe} denotes a pipeline temperature of an outdoor unit of the air conditioner; and a method for determining the third preset duration includes: controlling the second defrosting stage to stop operating when T_{outer pipe} is greater than or equal to 0° C. for 30 s, and alternatively, the third preset duration reaches 60 s.

In some embodiments, the fourth preset duration is greater than or equal to 10 s and less than or equal to 120 s.

In another aspect, the disclosure provides an air conditioner. The air conditioner is suitable for the above method for controlling an air conditioner and includes an indoor heat exchanger, a compressor, an outdoor heat exchanger, and an electronic expansion valve that are sequentially connected, the compressor is arranged between the indoor heat exchanger and the outdoor heat exchanger, and the electronic expansion valve is arranged between the outdoor heat exchanger and the indoor heat exchanger.

The method for controlling an air conditioner of the disclosure includes: controlling the air conditioner to enter the defrosting mode when the air conditioner operates in a heating mode; acquiring the current frequency F_{actual} of the compressor and the current opening P of the electronic expansion valve in the defrosting mode; controlling the air conditioner to enter the first defrosting stage and operate in the first defrosting stage for the first preset duration; and controlling the compressor to operate at the first frequency F₁ and the electronic expansion valve to operate at the first opening P₁ when the air conditioner is in the first defrosting stage. Moreover, in the method for controlling, the first frequency F₁ is determined according to the current frequency F_{actual} of the compressor and the indoor ambient temperature. Since the indoor ambient temperature indicates whether a temperature in a room is comfortable, when the indoor ambient temperature is high, the frequency may be decreased significantly. Accordingly, a primary objective of rapidly melting a frost layer is realized, and less heat is supplied to the room. On the contrary, when the indoor ambient temperature is low, a balance between melting of the frost layer on the outdoor unit of the air conditioner and heat supply to the room may be realized, and more heat may be supplied to the room because the ambient temperature is too low in this case. Moreover, an actual operation frequency of the air conditioner varies with an operation environment of the air conditioner. The first frequency is adjusted on the basis of an actual operation frequency of the air conditioner, instead of being directly adjusted to a fixed value, considering that the air conditioner may be dynamically adjusted on the basis of its own operation scene and state, so as to be more adaptive. Moreover, in the method for controlling, the first opening P₁ of the electronic expansion valve is determined according to a relation between the first frequency F₁ and the preset frequency Fₚᵣₑₛₑₜ. When the first frequency F₁ is greater than the preset frequency Fₚᵣₑₛₑₜ, the opening of the electronic expansion valve is adjusted to a maximum because rapid defrosting is required in this case. When the first frequency F₁ is less than the preset frequency Fₚᵣₑₛₑₜ, the frequency of the compressor is low, which is conducive to defrosting but unconducive to air outlet. Therefore, it is required to control the opening slightly. It can be seen that the method for controlling an air conditioner combines adjustment of the frequency of the compressor with adjustment of the opening of the electronic expansion valve. Accordingly, a better defrosting effect is realized, obvious decrease of the indoor ambient temperature in the defrosting mode is avoided, and a degree of user comfort is improved.

### BRIEF DESCRIPTION OF THE DRAWINGS

The accompanying drawings of the description are used for providing further understanding of the disclosure as a constituent part of the disclosure. Illustrative examples of the disclosure and their descriptions serve to explain the disclosure, instead of limiting the disclosure improperly. In the accompanying drawings:

FIG. 1 illustrates a flowchart of a method for controlling an air conditioner according to the disclosure.

### DETAILED DESCRIPTION OF THE EMBODIMENTS

It should be noted that examples of the disclosure and features in the examples can be mutually combined without conflicts. The disclosure will be described in detail below in conjunction with the accompanying drawings and the examples.

It should be noted that the following detailed descriptions are illustrative, and are intended to provide a further description of the disclosure. All the technical and scientific terms used herein have the same meanings as those commonly understood by those of ordinary skill in the art to which the disclosure pertains, unless defined otherwise.

It should be noted that the terms used herein are merely used to describe particular embodiments, and are not intended to limit illustrative embodiments according to the disclosure. As used herein, the singular form is also intended to include the plural form, unless clearly indicated in the context otherwise. In addition, it should also be understood that the terms “encompass” and/or “comprise” and “include” used in the description specify the presence of features, steps, operations, devices, assemblies, and/or their combinations.

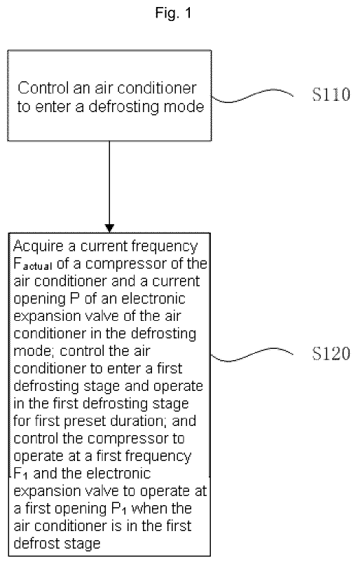

The disclosure provides a method for controlling an air conditioner. With reference to FIG. 1, the method includes:
S110, the air conditioner is controlled to enter a defrosting mode; and
S120, a current frequency F_{actual} of a compressor of the air conditioner and a current opening P of an electronic expansion valve of the air conditioner are acquired in the defrosting mode; the air conditioner is controlled to enter a first defrosting stage and operate in the first defrosting stage for first preset duration; and the compressor is controlled to operate at a first frequency F₁ and the electronic expansion valve to operate at a first opening P₁ when the air conditioner is in the first defrosting stage; where
a method for determining the first opening P₁ includes: F₁=kF_{actual}, where k is a frequency decrease adjustment coefficient, the frequency decrease adjustment coefficient k is determined according to an indoor ambient temperature T, the higher the indoor ambient temperature T is, the smaller the frequency decrease adjustment coefficient k is, and 0<k<1; and a method for determining the first opening P₁ includes: the first frequency F₁ is compared with a preset frequency Fₚᵣₑₛₑₜ, where P₁=Pₘₐₓ when F₁≥Fₚᵣₑₛₑₜ; and P₁=Pₘₐₓ*F₁/Fₚᵣₑₛₑₜ when F₁<Fₚᵣₑₛₑₜ.

The method for controlling an air conditioner of the disclosure includes: the air conditioner is controlled to enter the defrosting mode; the current frequency F_{actual} of the compressor and the current opening P of the electronic expansion valve are acquired in the defrosting mode; the air conditioner is controlled to enter the first defrosting stage and operate in the first defrosting stage for the first preset duration; and the compressor is controlled to operate at the first frequency F₁ and the electronic expansion valve to operate at the first opening P₁ when the air conditioner is in the first defrosting stage. Moreover, in the method for controlling, the first frequency F₁ is determined according to the current frequency F_{actual} of the compressor and the indoor ambient temperature. Since the indoor ambient temperature indicates whether a temperature in a room is comfortable, when the indoor ambient temperature is high, the frequency may be decreased significantly. Accordingly, a primary objective of rapidly melting a frost layer is realized, and less heat is supplied to the room. On the contrary, when the indoor ambient temperature is low, a balance between melting of the frost layer on an outdoor unit of the air conditioner and heat supply to the room may be realized, and more heat may be supplied to the room because the ambient temperature is too low in this case. Moreover, an actual operation frequency of the air conditioner varies with an operation environment of the air conditioner. The first frequency is adjusted on the basis of an actual operation frequency of the air conditioner, instead of being directly adjusted to a fixed value, considering that the air conditioner may be dynamically adjusted on the basis of its own operation scene and state, so as to be more adaptive. Moreover, in the method for controlling, the first opening P₁ of the electronic expansion valve is determined according to a relation between the first frequency F₁ and the preset frequency Fₚᵣₑₛₑₜ. When the first frequency F₁ is greater than the preset frequency Fₚᵣₑₛₑₜ, the opening of the electronic expansion valve is adjusted to a maximum because rapid defrosting is required in this case. When the first frequency F₁ is less than the preset frequency Fₚᵣₑₛₑₜ, the frequency of the compressor is low, which is conducive to defrosting but unconducive to air outlet. Therefore, it is required to control the opening slightly. It can be seen that the method for controlling an air conditioner combines adjustment of the frequency of the compressor with adjustment of the opening of the electronic expansion valve. Accordingly, a better defrosting effect is realized, obvious decrease of the indoor ambient temperature in the defrosting mode is avoided, and a degree of user comfort is improved.

The electronic expansion valve adjusts a refrigerant flow by adjusting the opening. The greater the opening is, the larger the flow of the electronic expansion valve is. The less the opening is, the smaller the flow of the electronic expansion valve is.

In some embodiments, a method for determining the frequency decrease adjustment coefficient k according to the indoor ambient temperature T includes: k=k₁ when T<15° C.; k=k₂ when 15° C.≤T<20° C.; k=k₃ when 20° C.≤T≤25° C.; and k=k₄ when T>25° C.; where 0.4≤k₁≤0.6; 0.4≤k₂≤0.6; 0.4≤k₃≤0.6; 0.4≤k₄≤0.6; and k₁≥k₂≥k₃≥k₄.

In some embodiments, the method for controlling an air conditioner includes: the indoor ambient temperature is measured; a temperature range (including T<15° C.; 15° C.≤T<20° C.; 20° C.≤T≤25° C.; and T>25° C.) to which the indoor ambient temperature belongs is determined; and the frequency decrease adjustment coefficient k is determined on the basis of different temperature ranges, so as to adjust the first frequency F₁. With the range of the frequency decrease adjustment coefficient k set, it is ensured that a frequency decrease amplitude of the air conditioner is rational. Therefore, incapacity of rapid defrosting caused by a too small frequency decrease amplitude of the first frequency F₁ of the compressor is avoided. Moreover, a too low air outlet temperature of the air conditioner caused by a too large frequency decrease amplitude is also avoided.

In some embodiments, 0.6≥k₁>k₂>k₃>k₄≥0.4.

In some embodiments, the preset frequency Fₚᵣₑₛₑₜ is 50 Hz. During specific implementation, since the first opening P₁ of the electronic expansion valve is adjusted according to the preset frequency Fₚᵣₑₛₑₜ, the first opening P₁ of the electronic expansion valve may be rationally set by setting a proper preset frequency Fₚᵣₑₛₑₜ.

In some embodiments, the first preset duration is greater than or equal to 30 s and less than or equal to 90 s. With the first preset duration set, it is ensured that the first opening P₁ of the air conditioner is not positioned at a maximum opening all the time during rapid defrosting. Therefore, the problem that the frequency of the compressor is increased after defrosting is completed, and a long time is consumed for the air conditioner to exhaust for recovering an original temperature, so that the air conditioner cannot recover a heating effect more rapidly is avoided.

In some embodiments, after the first defrosting stage ends, the method for controlling an air conditioner further includes: the air conditioner is controlled to enter a second defrosting stage and operate in the second defrosting stage for third preset duration; where the compressor operates at a third frequency F₃, and the electronic expansion valve operates at a third opening P₃ when the air conditioner is in the second defrosting stage, the third frequency F₃ is greater than the first frequency F₁, and the third opening P₃ is less than the first opening P₁; and a frequency of the compressor is controlled to increase from the third frequency F₃ to the current frequency F_{actual}, and an opening of the electronic expansion valve is controlled to decrease from the third opening P₃ to the current opening P after the second defrosting stage ends, so that the air conditioner exits the defrosting mode.

During specific implementation, in the second defrosting stage (an end phase of the defrosting mode), the third frequency F₃ of the compressor is controlled to be greater than the first frequency F₁, and the third opening P₃ is controlled to be less than the first opening P₁. Therefore, the indoor temperature is not as low as that in the first defrosting stage, a proper defrosting effect is ensured, and the air conditioner is prepared for normal heating after exiting the defrosting mode.

In some embodiments, after the first defrosting stage and before the second defrosting stage, the method for controlling an air conditioner further includes: the air conditioner is controlled to enter a transitional defrosting stage and operate in the transitional defrosting stage for second preset duration; where the compressor operates at a second frequency F₂, and the electronic expansion valve operates at a second opening P₂ when the air conditioner is in the transitional defrosting stage, the second frequency F₂ is greater than the first frequency F₁ and less than the third frequency F₃, and the second opening P₂ is less than the first opening P₁ and greater than the third opening P₃.

During specific implementation, with the second frequency F₂ and the second opening P₂ set in the transitional defrosting stage, the openings of the electronic expansion valve and the frequencies of the compressor in the first defrosting stage and the second defrosting stage are not changed rapidly. Therefore, a defrosting effect is ensured, a too large indoor temperature decrease amplitude is avoided, and comfort is improved.

In some embodiments, after the second defrosting stage ends, and before the opening of the electronic expansion valve is decreased from the third opening P₃ to the current opening P, the method for controlling the air conditioner further includes: the opening of the electronic expansion valve is maintained at the third opening P₃ for fourth preset duration.

During specific implementation, when the frequency of the compressor is increased from the third frequency F₃ to the current frequency F_{actual}, if the opening is directly decreased from the third opening P₃ to the current opening P, rapid throttling leads to sharp decrease of a pipeline temperature of the outdoor unit of the air conditioner, so that a frost layer is re-generated on a pipeline. Even if the frost layer disappears due to smooth operation of the air conditioner in a later stage, in the presence of a small amount of condensed water, the air conditioner is more likely to be frosted in the later stage.

In some embodiments, a method for determining the second frequency F₂ includes: F₂=F₁+ΔF₁, where 0 Hz≤ΔF₁₅ Hz. With such a setting, dramatic changes of the air outlet temperature and the defrosting effect after the second frequency F₂ is changed sharply with respect to the first frequency F₁ are avoided.

In some embodiments, 0 Hz<ΔF₁≤5 Hz.

In some embodiments, the method for determining the second frequency F₂ includes: the first frequency F₁ is compared with the preset frequency Fₚᵣₑₛₑₜ, where ΔF₁=1 Hz when F₁≥Fₚᵣₑₛₑₜ; and ΔF₁=2 Hz when F₁<Fₚᵣₑₛₑₜ. With such a setting, it is ensured that the second frequency F₂ does not have an obvious difference with respect to the preset frequency Fₚᵣₑₛₑₜ, so that the air outlet temperature and the defrosting effect are in a stable state.

In some embodiments, a method for determining the second opening P₂ includes: P₂=4/5*P₁*F₂/Fₚᵣₑₛₑₜ, where an upper limit of the second opening P₂ is 450 steps, and in other words, P₂ is required to be less than 450 steps. With such a setting, it is ensured that the second opening P₂ is less than the first opening P₁, and the opening of the electronic expansion valve is prevented from being decreased sharply from the first opening P₁ to the third opening P₃ after the air conditioner enters the second defrosting stage from the first defrosting stage.

In some embodiments, the second preset duration is greater than or equal to 30 s and less than or equal to 90 s. With the second preset duration set, a buffer time is provided for the air conditioner to enter the second defrosting stage from the first defrosting stage.

In some embodiments, a method for determining the third frequency F₃ includes: F₃=F₂+ΔF₂, where 0 Hz≤ΔF₂≤5 Hz. With such a setting, dramatic changes of the air outlet temperature and the defrosting effect after the third frequency F₃ is changed sharply with respect to the first frequency F₂ are avoided.

In some embodiments, 0 Hz<ΔF₂≤5 Hz.

In some embodiments, the method for determining the third frequency F₃ includes: the second frequency F₂ is compared with the preset frequency Fₚᵣₑₛₑₜ, where ΔF₂=1 Hz when F₂≥Fₚᵣₑₛₑₜ, and ΔF₂=2 Hz when F₂<Fₚᵣₑₛₑₜ. With such a setting, it is ensured that the third frequency F₃ does not have an obvious difference with respect to the preset frequency Fₚᵣₑₛₑₜ, so that the air outlet temperature and the defrosting effect are in a stable state.

In some embodiments, a method for determining the third opening P₃ includes: P₃=3/5*P₂*F₃/Fₚᵣₑₛₑₜ, where an upper limit of the third opening P₃ is 350 steps, and in other words, P₃ is required to be less than 350 steps. With such a setting, the third opening P₃ is prevented from being too large. Therefore, a balance between the air outlet temperature and the defrosting effect is ensured, and the electronic expansion valve is prepared for being restored to the original opening from the opening P.

In some embodiments, T_{outer pipe} denotes a pipeline temperature of an outdoor unit of the air conditioner; and a method for determining the third preset duration includes: the second defrosting stage is controlled to stop operating when T_{outer pipe} is greater than or equal to 0° C. for 30 s, and alternatively, the third preset duration reaches 60 s. With such a setting, it is ensured that the air conditioner can operate normally after defrosting of the outdoor unit of the air conditioner is completed.

In some embodiments, the fourth preset duration is greater than or equal to 10 s and less than or equal to 120 s. With the fourth preset duration set, re-generation of a frost layer on a pipeline after the opening of the electronic expansion valve is decreased sharply is avoided.

During heating of a common air conditioner, since an outdoor heat exchanger absorbs heat from outdoor air, a temperature around the outdoor heat exchanger is low, and water vapor in the air condenses into frost and adheres to a surface of the outdoor heat exchanger. In consequence, a heat exchange capacity of the outdoor heat exchanger is affected, and an air outlet temperature of the air conditioner in the room and a degree of user comfort are affected accordingly. After the frost layer reaches a certain thickness, it is required to carry out a defrosting operation. During defrosting, since the air conditioner does not supply heat to the room and even absorbs indoor heat, the degree of user comfort is more undesirable. However, the method for controlling an air conditioner of the disclosure relieves the above problems. A primary objective of the first defrosting stage is to realize rapid defrosting. A primary objective of the second defrosting stage is to prepare the air conditioner for recovery of heating, and in other words, take comfort into primary consideration. The transitional defrosting stage is a transitional stage between the first defrosting stage and the second defrosting stage. In the defrosting mode, the reason why the opening of the electronic expansion valve cannot be maintained at the maximum opening all the time is that if the opening is positioned at the maximum opening all the time, the frequency of the compressor of the air conditioner is increased after defrosting is completed, and a long time is consumed for the air conditioner to exhaust for recovering an original temperature, so that the air conditioner cannot recover a heating effect more rapidly. In the method for controlling of the disclosure, the frequency of the compressor and the opening of the electronic expansion valve are under joint control, and an optimal defrosting effect and a most comfortable air outlet temperature are realized through three stages of the joint control. Moreover, the method for controlling can be directly popularized and applied, no cost is increased, rapid defrosting can be realized, heating duration can be prolonged, and the degree of user comfort can be improved.

The disclosure further provides an air conditioner. The air conditioner is suitable for the method for controlling an air conditioner in the above example and includes an indoor heat exchanger, a compressor, an outdoor heat exchanger, and an electronic expansion valve that are sequentially connected, the compressor is arranged between the indoor heat exchanger and the outdoor heat exchanger, and the electronic expansion valve is arranged between the outdoor heat exchanger and the indoor heat exchanger.

It can be seen from the above description that the above examples of the disclosure implement the technical effects as follows:

The method for controlling an air conditioner of the disclosure includes: the air conditioner is controlled to enter the defrosting mode; the current frequency F_{actual} of the compressor and the current opening P of the electronic expansion valve are acquired in the defrosting mode; the air conditioner is controlled to enter the first defrosting stage and operate in the first defrosting stage for the first preset duration; and the compressor is controlled to operate at the first frequency F₁ and the electronic expansion valve to operate at the first opening P₁ when the air conditioner is in the first defrosting stage. Moreover, in the method for controlling, the first frequency F₁ is determined according to the current frequency F_{actual} of the compressor and the indoor ambient temperature. Since the indoor ambient temperature indicates whether a temperature in a room is comfortable, when the indoor ambient temperature is high, the frequency may be decreased significantly. Accordingly, a primary objective of rapidly melting the frost layer is realized, and less heat is supplied to the room. On the contrary, when the indoor ambient temperature is low, a balance between melting of the frost layer on the outdoor unit of the air conditioner and heat supply to the room may be realized, and more heat may be supplied to the room because the ambient temperature is too low in this case. Moreover, an actual operation frequency of the air conditioner varies with an operation environment of the air conditioner. The first frequency is adjusted on the basis of an actual operation frequency of the air conditioner, instead of being directly adjusted to a fixed value, considering that the air conditioner may be dynamically adjusted on the basis of its own operation scene and state, so as to be more adaptive. Moreover, in the method for controlling, the first opening P₁ of the electronic expansion valve is determined according to a relation between the first frequency F₁ and the preset frequency Fₚᵣₑₛₑₜ. When the first frequency F₁ is greater than the preset frequency Fₚᵣₑₛₑₜ, the opening of the electronic expansion valve is adjusted to a maximum because rapid defrosting is required in this case. When the first frequency F₁ is less than the preset frequency Fₚᵣₑₛₑₜ, the frequency of the compressor is low, which is conducive to defrosting but unconducive to air outlet. Therefore, it is required to control the opening slightly. It can be seen that the method for controlling an air conditioner combines adjustment of the frequency of the compressor with adjustment of the opening of the electronic expansion valve. Accordingly, a better defrosting effect is realized, obvious decrease of the indoor ambient temperature in the defrosting mode is avoided, and the degree of user comfort is improved.

It should be noted that the terms “first”, “second”, etc. in the description, the claims, and the above accompanying drawings of the disclosure are used to distinguish between similar objects, instead of necessarily describing a particular sequence or a successive order. It should be understood that data used in such a way can be interchanged where appropriate, so that the embodiments of the disclosure described herein can be implemented in other sequences than those illustrated or described herein. In addition, the terms “comprise”, “include”, “have”, and their any variations are intended to cover non-exclusive inclusions. For example, processes, methods, systems, products, or devices encompassing a series of steps or units can include other steps or units that are not explicitly listed or are inherent to these processes, methods, products, or devices, without being limited to those steps or units explicitly listed.

For ease of description, the spatially-relative terms such as “on . . . ”, “above . . . ”, “on an upper surface of . . . ”, and “over” can be used herein to describe the spatial position relation between one device or feature and another device or feature as shown in the figures. It should be understood that the spatially-relative terms are intended to encompass different orientations in use or operation except for the orientation of the device described in the figures. For example, if the device in the accompanying drawings is inverted, a device described as “above another device or configuration” or “on another device or configuration” will then be located as “below another device or configuration” or “underneath another device or configuration”. Therefore, the illustrative term “above . . . ” can indicate two orientations “above . . . ” and “below . . . ”. The device can also be located in other different ways (being rotated by 90 degrees or positioned in another orientation), and the spatially-relative descriptions used herein are interpreted correspondingly.

What are described above are merely preferred examples of the disclosure, and are not intended to limit the disclosure. Those skilled in the art can make various changes and variations to the disclosure. Any modifications, equivalent replacements, improvements, etc. made within the spirit and principles of the disclosure should fall within the scope of protection of the disclosure.

1. A method for controlling an air conditioner, comprising:
controlling the air conditioner to enter a defrosting mode;
acquiring a current frequency F_{actual} of a compressor of the air conditioner and a current opening P of an electronic expansion valve of the air conditioner in the defrosting mode;
controlling the air conditioner to enter a first defrosting stage and operate in the first defrosting stage for first preset duration; and controlling the compressor to operate at a first frequency F₁ and the electronic expansion valve to operate at a first opening P₁ when the air conditioner is in the first defrosting stage; wherein
a method for determining the first frequency F₁ comprises: F₁=kF_{actual}, wherein k is a frequency decrease adjustment coefficient, the frequency decrease adjustment coefficient k is determined according to an indoor ambient temperature T, the higher the indoor ambient temperature T is, the smaller the frequency decrease adjustment coefficient k is, and 0<k<1; and
a method for determining the first opening P₁ comprises: comparing the first frequency F₁ with a preset frequency Fₚᵣₑₛₑₜ, wherein P₁=Pₘₐₓ when F₁≥Fₚᵣₑₛₑₜ; and P₁-Pₘₐₓ*F₁/Fₚᵣₑₛₑₜ when F₁<Fₚᵣₑₛₑₜ.

2. The method for controlling an air conditioner as claimed in claim 1, wherein a method for determining the frequency decrease adjustment coefficient k according to the indoor ambient temperature T comprises:
k=k₁ when T<15° C.;
k=k₂ when 15° C.≤T<20° C.;
k=k₃ when 20° C.≤T≤25° C.; and
k=k₄ when T>25° C.; wherein
0.4≤k₁≤0.6; 0.4≤k₂≤0.6; 0.4≤k₃≤0.6; 0.4≤k₄≤0.6; and k₁≥k₂≥k₃≥k₄.

3. The method for controlling an air conditioner as claimed in claim 1, wherein the preset frequency Fₚᵣₑₛₑₜ is 50 Hz.

4. The method for controlling an air conditioner as claimed in claim 1, wherein the first preset duration is greater than or equal to 30 s and less than or equal to 90 s.

5. The method for controlling an air conditioner as claimed in claim 1, wherein after the first defrosting stage ends, the method for controlling an air conditioner further comprises:
controlling the air conditioner to enter a second defrosting stage and operate in the second defrosting stage for third preset duration; wherein the compressor operates at a third frequency F₃, and the electronic expansion valve operates at a third opening P₃ when the air conditioner is in the second defrosting stage, the third frequency F₃ is greater than the first frequency F₁, and the third opening P₃ is less than the first opening P₁; and
controlling a frequency of the compressor to increase from the third frequency F₃ to the current frequency F_{actual}, and controlling an opening of the electronic expansion valve to decrease from the third opening P₃ to the current opening P after the second defrosting stage ends, so that the air conditioner exits the defrosting mode.

6. The method for controlling an air conditioner as claimed in claim 5, wherein after the first defrosting stage and before the second defrosting stage, the method for controlling an air conditioner further comprises:
controlling the air conditioner to enter a transitional defrosting stage and operate in the transitional defrosting stage for second preset duration; wherein
the compressor operates at a second frequency F₂, and the electronic expansion valve operates at a second opening P₂ when the air conditioner is in the transitional defrosting stage, the second frequency F₂ is greater than the first frequency F₁ and less than the third frequency F₃, and the second opening P₂ is less than the first opening P₁ and greater than the third opening P₃.

7. The method for controlling an air conditioner as claimed in claim 5, wherein after the second defrosting stage ends, and before the opening of the electronic expansion valve is decreased from the third opening P₃ to the current opening P, the method for controlling an air conditioner further comprises:
maintaining the opening of the electronic expansion valve at the third opening P₃ for fourth preset duration.

8. The method for controlling an air conditioner as claimed in claim 6, wherein a method for determining the second frequency F₂ comprises: F₂=F₁+ΔF₁, wherein 0 Hz≤ΔF₁≤5 Hz.

9. The method for controlling an air conditioner as claimed in claim 8, wherein a method for determining the second frequency F₂ comprises:
comparing the first frequency F₁ with the preset frequency Fₚᵣₑₛₑₜ, wherein ΔF₁=1 Hz when F₁≥Fₚᵣₑₛₑₜ; and ΔF₁=2 Hz when F₁<Fₚᵣₑₛₑₜ.

10. The method for controlling an air conditioner as claimed in claim 6, wherein a method for determining the second opening P₂ comprises: P₂=4/5*P₁*F₂/Fₚᵣₑₛₑₜ, wherein an upper limit of the second opening P₂ is 450 steps.

11. The method for controlling an air conditioner as claimed in claim 6, wherein the second preset duration is greater than or equal to 30 s and less than or equal to 90 s.

12. The method for controlling an air conditioner as claimed in claim 6, wherein a method for determining the third frequency F₃ comprises: F₃=F₂+ΔF₂, wherein 0 Hz≤ΔF₂≤5 Hz.

13. The method for controlling an air conditioner as claimed in claim 12, wherein the method for determining the third frequency F₃ comprises:
comparing the second frequency F₂ with the preset frequency Fₚᵣₑₛₑₜ, wherein ΔF2=1 Hz when F₂≥Fₚᵣₑₛₑₜ; and ΔF₂=2 Hz when F₂<Fₚᵣₑₛₑₜ.

14. The method for controlling an air conditioner as claimed in claim 6, wherein a method for determining the third opening P₃ comprises: P₃−3/5*P₂*F₃/Fₚᵣₑₛₑₜ, wherein an upper limit of the third opening P₃ is 350 steps.

15. The method for controlling an air conditioner as claimed in claim 5, wherein T_{outer pipe} denotes a pipeline temperature of an outdoor unit of the air conditioner; and a method for determining the third preset duration comprises: controlling the second defrosting stage to stop operating when T_{outer pipe} is greater than or equal to 0° C. for 30 s, and alternatively, the third preset duration reaches 60 s.

16. The method for controlling an air conditioner as claimed in claim 7, wherein the fourth preset duration is greater than or equal to 10 s and less than or equal to 120 s.

17. An air conditioner, suitable for the method for controlling an air conditioner as claimed in claim 1, wherein the air conditioner comprises an indoor heat exchanger, a compressor, an outdoor heat exchanger, and an electronic expansion valve that are sequentially connected, the compressor is disposed between the indoor heat exchanger and the outdoor heat exchanger, and the electronic expansion valve is disposed between the outdoor heat exchanger and the indoor heat exchanger.

18. The air conditioner as claimed in claim 17, wherein a method for determining the frequency decrease adjustment coefficient k according to the indoor ambient temperature T comprises:
k=k₁ when T<15° C.;
k=k₂ when 15° C.≤T<20° C.;
k=k₃ when 20° C.≤T≤25° C.; and
k=k₄ when T>25° C.; wherein
0.4≤k₁≤0.6; 0.4≤k₂≤0.6; 0.4≤k₃≤0.6; 0.4≤k₄≤0.6; and k₁≥k₂≥k₃≥k₄.

19. The air conditioner as claimed in claim 17, wherein after the first defrosting stage ends, the method for controlling an air conditioner further comprises:
controlling the air conditioner to enter a second defrosting stage and operate in the second defrosting stage for third preset duration; wherein the compressor operates at a third frequency F₃, and the electronic expansion valve operates at a third opening P₃ when the air conditioner is in the second defrosting stage, the third frequency F₃ is greater than the first frequency F₁, and the third opening P₃ is less than the first opening P₁; and
controlling a frequency of the compressor to increase from the third frequency F₃ to the current frequency F_{actual}, and controlling an opening of the electronic expansion valve to decrease from the third opening P₃ to the current opening P after the second defrosting stage ends, so that the air conditioner exits the defrosting mode.

20. The air conditioner as claimed in claim 17, wherein after the first defrosting stage and before the second defrosting stage, the method for controlling an air conditioner further comprises:
controlling the air conditioner to enter a transitional defrosting stage and operate in the transitional defrosting stage for second preset duration; wherein
the compressor operates at a second frequency F₂, and the electronic expansion valve operates at a second opening P₂ when the air conditioner is in the transitional defrosting stage, the second frequency F₂ is greater than the first frequency F₁ and less than the third frequency F₃, and the second opening P₂ is less than the first opening P₁ and greater than the third opening P₃.
